(19) United States
(12) Patent Application Publication
(10) Pub. No.: US 2003/0014444 A1
(43) Pub. Date: Jan. 16, 2003

(54) Discriminating system for a pornographic file and the discriminating method

(76) Inventor: Martin Wu, Taipei (TW)

Correspondence Address: RABIN & BERDO, P.C., Suite 500, 1101 14th Street, N.W., Washington, DC, 20005, US

(21) Appl. No.: 10/107,315

(22) Filed: Mar. 28, 2002

(30) Foreign Application Priority Data
Jun. 27, 2001 (TW) 90115664

(51) Int. Cl. G06F 15/00

(52) U.S. Cl. 707/515

(57) ABSTRACT

A discriminating system and the corresponding discriminating method for the pornographic file is provided. The invention uses a world part and a picture part for double inspection, so as to improve the discerning precision. The pornographic picture discerning engine is usually used to discern the picture part. In addition, a word comparing engine is also used to analyze the words, so as to obtain the relative information for the picture and improve precision of the pornographic discerning ability. The discriminating system for pornographic picture includes a word divider, a pornographic picture discerning engine, and a word comparing engine. The word divider is used to receive the multiplex file and separate it into the word part and the picture part for inspections by the pornographic picture discerning engine and the word comparing engine. Finally, the multiplex file is judged whether or not a pornographic file, according to the pornographic discerning index.

This application incorporates by reference Taiwanese application Serial No. 90115664, filed on Jun. 27, 2001.

### BACKGROUND OF THE INVENTION

1. Field of the Invention

This invention is directed to a filtering system for pornographic information and the filtering method. More particularly, the invention is directed to a discriminating system and the discriminating method for a pornographic file.

2. Description of Related Art

As the network communication and the information techniques have been fast updated day by day, information transmission and its sharing use have also been fast and convenient. A user can go through Internet to connect to the World Wide Web (WWW) system and use all the information and data provided by the WWW system. The development of network has brought us a fast and convenient communication environment and the information flow. It has also created a rich and secret cyberspace. Network users do not necessary to reveal their actual personal status and can freely play in it. Recently, the network criminal events occur in a great increasing rate, and have been well concerned by people. Particularly, the pornographic criminal events made through the network have been flooding over the society and harming the adolescents.

In order to effectively use the network resources but not to cause a negative effect from the network for the adolescents, some filtering software used to avoid the pornographic information transmitted in network are sold in the current market. The software has a large station database, which can be installed in the computer that has provided the service to entry the network. The filtering software is, for example, X-stop or SurfWatch used in the network station. When the users entry the network and try to connect a web site which is on the list of the filtering software, the connection would not be successful, such that more than thousand and thousand of pornographic web sites, file transfer protocol (FTP) centers, and news groups can be filtered. However, things are fast changing in the network world. New home pages or updated pages may occur in every minute or second and are tagged as the illegal information. If the filtering software is not constantly updated, once the pornographic websites changes their network addresses or new web sites are made, the filtering software still cannot effectively avoid the pornographic invasion.

Once all the data file, voice, image, and so on in our practical life are converted into digital type, they can be distributed to the whole world through the network and be shared in fillip of time. A lot of pornographic web sites provide a large amount of pornographic information. The network users can easily touch the pornographic worlds, pictures, motion pictures, and so on. Some people even also use the E-mail to send anonymous mails or falsifying other person to distribute pornographic worlds, pictures, images, voice, and so on, which are illegal or improper information. The E-mail disturbs other persons, causing the user to be uncomfortable or inconvenient. In a company, the boss of the company also complains about some employees who would download the pornographic pictures from the network or transmitting pornographic pictures through E-mail. Since most portion of the bandwidth of the network is occupied by the transmitting the pornographic pictures, company resource is spent without any profit.

However, if doubtable picture information is inspected and filtered only by pornographic discerning engine, the discerning result is still not satisfied due to the discerning techniques has its limitation. The pornographic discerning engine can only roughly judge whether the picture is a pornographic picture. The percentage to detect out the pornographic picture is only equivalent to the ability for ten years old child. Sometime an ambiguity occurs.

### SUMMARY OF THE INVENTION

It is an objective of the present invention to provide a discriminating system and the discriminating method for a pornographic file, using a world part and a picture part for double inspection, so as to improve the discerning precision.

In accordance with one objective of the present invention, a discriminating method for a pornographic file is provided, used to filter a multiplex file transmitted in network. The multiplex file includes a word part and a picture part. The discriminating method includes first inputting the multiplex file. Then, the word part and the picture part are separated. Then, the word part and the picture part are respectively inspected, and the pornographic discerning index is computed. The multiplex file is judged to be whether or not a pornographic file.

In accordance with another objective of the present invention, a discriminating system for a pornographic file is provided, used to filter a multiplex file transmitted in network. The multiplex file includes a word part and a picture part. The discriminating system includes a file divider, a word comparing engine, and a pornographic picture discerning engine. The file divider is used to separate the word part and the picture part. The word comparing engine is coupled to a pornographic word database, used to inspect the word part, and compute a word pornographic index. The pornographic picture discerning engine is used to inspect the picture part, and compute a picture pornographic index, and add the received word pornographic index and the received picture pornographic index as a pornographic discerning index. In addition, the discriminating system is also coupled to an intercepting unit. When the discriminating finds a pornographic file, the intercepting unit starts to intercept the pornographic file.

### BRIEF DESCRIPTION OF DRAWINGS

The invention can be more fully understood by reading the following detailed description of the preferred embodiments, with reference made to the accompanying drawings, wherein:

FIG. 1 is a drawing, schematically illustrating a pornographic e-mail;

FIG. 2 is a block diagram, schematically illustrating a discriminating system for a pornographic file, according to a preferred embodiment of the invention;

FIG. 3 is a process flow diagram, schematically illustrating a discriminating method for a pornographic file, according to a preferred embodiment of the invention;

FIG. 4 is an inspection diagram, schematically illustrating an operation method for the word comparing engine, according to a preferred embodiment of the invention; and

FIG. 5 is an inspection diagram, schematically illustrating an operation method for the pornographic picture discerning engine, according to a preferred embodiment of the invention.

### DETAILED DESCRIPTION OF PREFERRED EMBODIMENTS

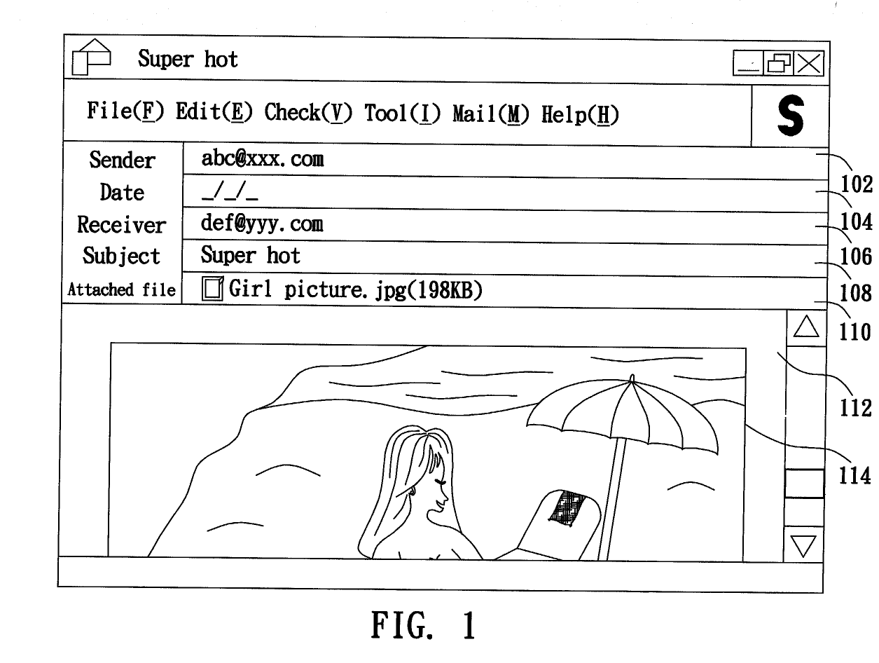

A pornographic file includes a file having a word part and a picture part, such as a network home page or an e-mail. Usually, the word part and the picture part have certain relation. For the e-mail as an example, FIG. 1 is a schematic drawing for a pornographic e-mail. An e-mail basically includes sender 102, date 104, receiver 106, subject 108 and content 112. In addition, when the e-mail has an attached file, the attached file is attached to the end of the mail, to be treated as a part of the mail for transmission. The information of sender 102 and the receiver 106 respectively are the e-mail address abc@xxx.com of the sender and the e-mail address def@yyy.com of the receiver. The date 104 records the year, month, and day when the e-mail is sent. The subject 108 is the topic for this e-mail. The content 112 is the content of the e-mail. Usually, the w subject 108 and the content 112 have strong relation. For example, a pornographic e-mail would have words like super hot, hot girl, super sexy, and so on in the subject 108, and the content 112 would include a half nude or full nude picture, or any pornographic picture. In order to avoid receiving a strange e-mail, such as attached with a pornographic file or picture and give the selection right to the person who does not want see these kind of pornographic mails, it is necessary to provide an instant inspection mechanism for the content of the information. It would be more effective to filter the e-mail with the pornographic file by directly inspecting on the doubtable words and picture files. Then, the adolescents can fully make use of the network resources without negative affection.

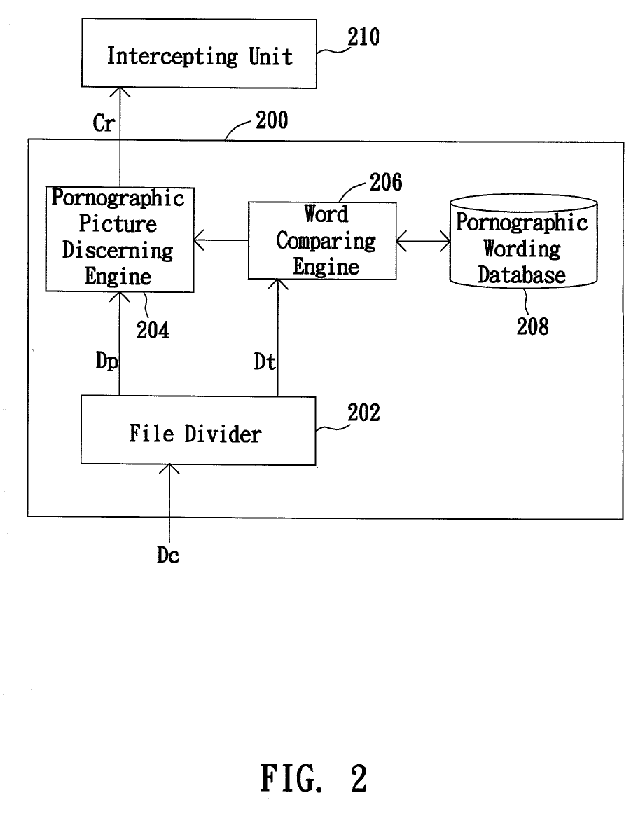

FIG. 2 is a block diagram, schematically illustrating a discriminating system for a pornographic file, according to a preferred embodiment of the invention. In FIG. 2, the discriminating system for a pornographic file of the invention uses the word part and the picture part for double inspection. It uses the pornographic picture discerning engine to discern the picture. In addition, words to describe the picture are also analyzed, so as to obtain the related information about the picture. It improves the discerning precision for the pornographic picture. As shown in FIG. 2, the discriminating system for a pornographic file 200 is used for filtering the multiplex file transmitted through the network. The discriminating system includes a file divider 202, a pornographic picture discerning engine 204, and a word comparing engine 206.

The file divider 202 divides the received multiplex file information Dc into a word part Dt and a picture part Dp, and distributes the word part Dt to the word comparing engine 206 and distributes the picture part Dp to the pornographic picture discerning engine 204. The word comparing engine 206 is used to inspect the word part and computes the word pornographic index for the word part. The word pornographic index is exported to the pornographic picture discerning engine 204. Moreover, the word comparing engine 206 is also connected to a pornographic word database 208, which includes pornographic words provided for word comparing engine 206 to search and compare the word part. The word comparing engine 206 also gives a pornographic weight for each kind of pornographic words. Different pornographic word has different weight. For example, it can be almost sure that the words like super hot, pornographic picture, hot girl, and so on indicate the related picture as a pornographic picture. Therefore, those words have larger pornographic weight. However, for example, the words of young girl picture or soft pornographic implying words could be just the life pictures for a young girl or some fruits tasting good. Therefore, these kinds of words have smaller pornographic weight. The word comparing engine 206 assigns the corresponding weight for the word part being inspected, and calculates the word pornographic index for the multiplex file. The pornographic picture discerning engine 204 is used to inspect the picture part, so as to calculate the picture pornographic index for the picture part, and then sums the received word pornographic index and the picture pornographic index to obtain the pornographic discerning index. The pornographic picture discerning engine 204 employs the statistic manner as the discriminating base, wherein the mathematic derivation is used to discern the featuring points of the picture to be inspected. The featuring points for the picture usually includes color, style, position, size, strain distribution, object's type, and so on. Since the pornographic picture usually is semi-nude or full nude, the skin color ratio can serve as a featuring point provided to the pornographic picture discerning engine 204 for performing inspection. Further still, the discriminating system 200 for a pornographic file can be connected to an intercepting unit 210. When discriminating system 200 for a pornographic file judges out the multiplex file as a pornographic file, according to the pornographic index, the pornographic picture discerning engine 204 export a control signal Cr and informs the intercepting unit 210 to intercept the pornographic file. Therefore, after installing the discriminating system 200 for a pornographic file on the mail server for the company, it can detect the attached picture in the incoming/outgoing mails and effectively avoid that the company employees occupies the network bandwidth for transmitting pornographic pictures. Furthermore, the discriminating system 200 for a pornographic file can also be installed on the other servers to filter the pornographic home page or can be installed on the personal computer for discerning those unclear files before open the files.

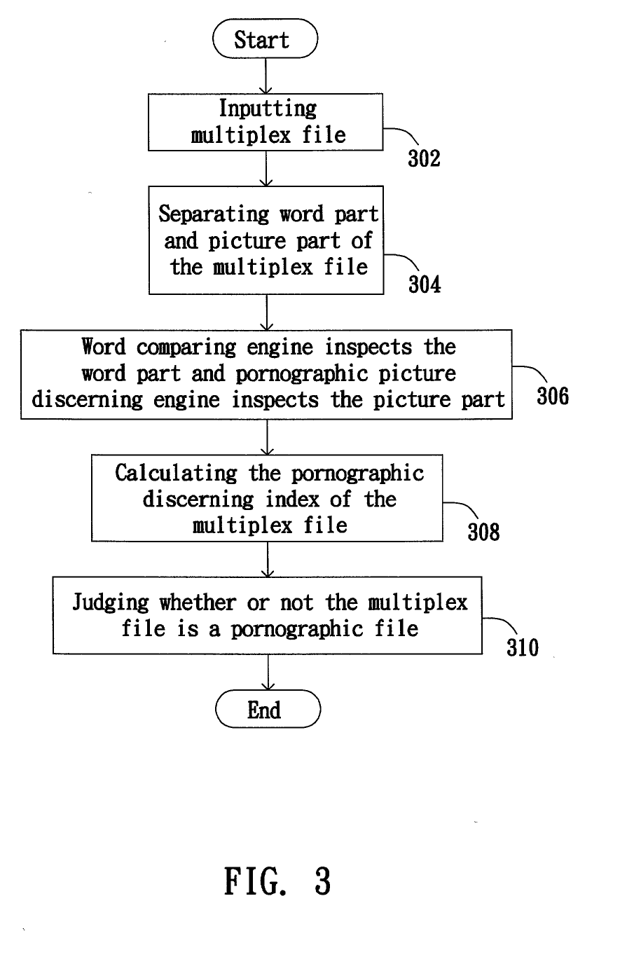

FIG. 3 is a process flow diagram, schematically illustrating a discriminating method for a pornographic file, according to a preferred embodiment of the invention. The discriminating method for a pornographic file is to filter the multiplex files transmitted through the network. The pornographic file includes a word part and a picture part. In FIG. 3, starting from the step 302, the multiplex file is input to the file divider 202. In the step 304, the file divider 202 divides the multiplex file into a word part and a picture part. The word part and the picture part are respectively sent to the word comparing engine 206 and the pornographic picture discerning engine 204. In the step 306, the word comparing engine 206 and the pornographic picture discerning engine 204 respectively inspect the word part and the picture part. After respectively inspecting the word part and the picturing part, the process goes to the step 308, the pornographic discerning index of the multiplex file is computed out. In the step 310, according to the pornographic discerning index of the multiplex file, whether or not the file is a pornographic file is judged and the discriminating method for a pornographic file accomplishes.

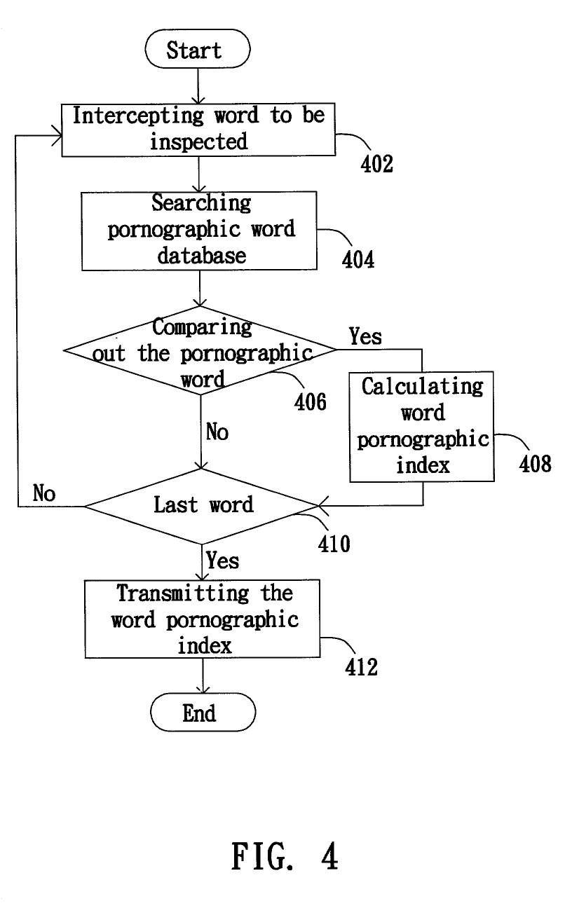

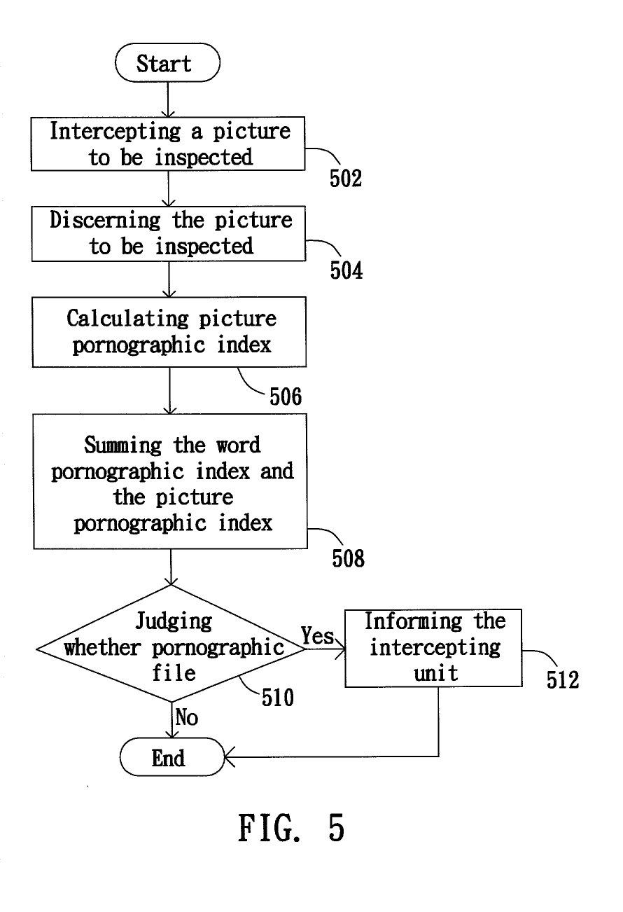

For example, it is supposed that the multiplex file in FIG. 1 is an e-mail with attached picture 114. In FIGS. 4 and 5, the inspection method for the word comparing engine 206 is the step 402, fetching the and words to be inspected in the email, such as the title of in the subject 108 with respect to step 404 about searching pornographic word in the database 208. In the step 406, it is judged that whether or not pornographic words are carried. When the word comparing engine 206 finds identical or similar pornographic words in the database 208, the process enters the step 408 about computing the pornographic index. For example, the subject 108 in FIG. 1 has a word of “super hot”, and the word comparing engine 206 can find the same words of “super hot” in the word pornographic database 208. If the super hot has a weight of 0.1, then the word pornographic index is 0.1. In the step 410, it is checked whether the currently inspected word is the last word. If it is not, the process returns back to the step 402 for the continuously fetching the next word to be inspected and repeating the steps 404, 406, 408. For the main in FIG. 1, the file name of the attached file 110 is “girl picture” and if the “girl picture” has a weight of 0.05, then in the step 408, the word pornographic index accumulates up to 0.15 (=0.1+0.05). After the inspection on the word part is complete, the word comparing engine 206 in the step 412 exports the word pornographic index to the pornographic picture discerning engine 204.

FIG. 5 is an inspection diagram, schematically illustrating an operation method for the pornographic picture discerning engine, according to a preferred embodiment of the invention. In FIG. 5, the inspecting method for the pornographic picture discerning engine 204 starts from the step 502 for fetching the picture to be inspected. In the step 504, the picture is inspected. In the step 506, the picture pornographic index is calculated. In FIG. 1, if the pornographic picture discerning engine 204 inspects the attached picture 114 and discerns the picture to have the picture pornographic index of 0.5, it indicates that the attached picture 114 has 50% to be a pornographic picture and has 50% is not a pornographic picture. In this situation, the picture cannot be judged whether the picture actually is a pornographic picture. At this moment, the pornographic picture discerning engine 204 receives the wording pornographic index of 0.15 from the word comparing engine 206. In the step 508, the total sum of the word pornographic picture and the picture pornographic picture is then 0.65 (=0.5+0.15) for the pornographic discerning index. In this situation, the pornography possibility for the attached picture 114 is raised. In step 510, the multiplex file, according to the pornographic discerning index, is judged to be a pornographic picture. If the multiplex file is judged to be a pornographic file, the process goes to the step 512 to inform the intercepting unit 210 to intercept the multiplex file. If the word comparing engine 206 cannot find any pornographic words in the word part, the word pornographic index appears a negative value, such as −01. In step 508, the total pornographic discerning index is 0.4 (=0.5-0.1). Therefore, through the inspection from the word comparing engine 206, the pornographic possibility is reduced, and then the multiplex file is judged to be a non-pornographic file. In this manner, the discerning precision for the pornographic picture is improved. Particularly, when the function of the pornographic picture discerning engine 204 may be invalid, the precision is still reliably maintained.

The discriminating system and the discriminating method for a pornographic file use the inspection on both the world part and the picture part for double inspection, so as to improve the discerning precision. The pornographic picture discerning engine is used to inspect the picture. In addition, words for describing the picture are analyzed, so as to obtain the relating information about the picture. Particularly, when the pornographic picture discerning engine 204 cannot work, the precision can antiseptically discern with the right result.

When the discriminating system 200 for a pornographic file of the invention is installed on the mail server of the company, it can detect the attached picture in the incoming/outgoing mails and effectively avoid that the company employees occupy the network bandwidth for transmitting pornographic pictures. The discriminating system 200 for a pornographic file can also be installed on the other servers to filter the pornographic home page or can be installed on the personal computer for discerning those unclear files before open them. The multiplex file carrying the pornographic picture is effectively filtered, such that the adolescent can fully use the network information without negative affection.

The invention has been described using exemplary preferred embodiments. However, it is understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A discriminating method for pornographic information, used to filter a multiplex file transmitted through a network, wherein the multiplex file includes a word part and a picture part, the method comprising:
(a1) inputting the multiplex file;
(a2) separating the word part and the picture part;
(a3) respectively inspecting the word part and the picture part; and
(a4) judging whether or not the multiplex file is a pornographic file.

2. The discriminating method for pornographic information according to claim 1, wherein between the step (a3) and the step (a4), the discriminating method further comprises:
(a31) calculating a pornographic discerning index for the multiplex file.

3. The discriminating method for pornographic information according to claim 1, wherein in the step (a4), when the multiplex file is judged to be a pornographic file, the multiplex file is intercepted.

4. The discriminating method for pornographic information according to claim 3, wherein in the step (a2), a file distributor is used to separate the word part and the picture part of the multiplex file.

5. The discriminating method for pornographic information according to claim 4, wherein after the step (a2), the method further includes a step: (a21) respectively distributing the word part and the picture part to a word comparing engine and a pornographic picture discerning engine by the file distributor.

6. The discriminating method for pornographic information according to claim 5, wherein in the step (a3), the word comparing engine inspects the word part.

7. The discriminating method for pornographic information according to claim 5, wherein in the step (a3), the pornographic picture discerning engine inspects the picture part.

8. The discriminating method for pornographic information according to claim 6, wherein the inspection process for the word comparing engine comprises:
(b1) fetching a word to be inspected from the word part;
(b2) searching and comparing the word to be inspected and a database pornographic word;
(b3) calculating a word pornographic index for the word part;
(b4) transmitting the word pornographic index to the word comparing engine.

9. The discriminating method for pornographic information according to claim 8, wherein in the step (b2) the word comparing engine search a pornographic word database.

10. The discriminating method for pornographic information according to claim 9, wherein the pornographic word database includes a plurality of database pornographic words.

11. The discriminating method for pornographic information according to claim 10, wherein the word comparing engine calculates the word pornographic index, according to every corresponding pornographic weight for the word part.

12. The discriminating method for pornographic information according to claim 7, wherein the inspection process for the pornographic picture discerning engine comprises:
(c1) fetching a picture to be inspected from the picture file;
(c2) discerning the picture to be inspected;
(c3) calculating a picture pornographic index for the picture part;
(c4) summing the word pornographic index and the picture pornographic index to obtain the pornographic discerning index; and
(c5) judging whether or not the multiplex file is a pornographic file, according to the pornographic discerning index.

13. The discriminating method for a pornographic information according to claim 12, wherein after the step (c5), when the multiplex file is determines as one pornographic file, the process enter the step (C6), and informs an intercepting unit to intercept the multiplex file.

14. The discriminating method for pornographic information according to claim 1, wherein the pornographic file is an e-mail attached with a pornographic picture.

15. A discriminating system for pornographic information, used to filter a multiplex file transmitted through network, wherein the multiplex file includes a word part and a picture part, the system comprising:
a file divider, used to separate the word part and the picture part;
a word comparing engine, coupled to a pornographic word database, used to inspect the word part and calculating a word pornographic index for the word part; and
a pornographic picture discerning engine, used to inspect the picture part, calculate a picture pornographic index for the picture part, and sum all the received word pornographic index and the picture pornographic index to be a pornographic discerning index.

16. The discriminating system for pornographic information according to claim 15, wherein the system is connected with an intercepting unit.

17. The discriminating system for pornographic information according to claim 16, wherein when the multiplex file is judged to be a type of pornographic file, the pornographic picture discerning engine transmits a control signal to inform the intercepting unit to intercept the multiplex file.

18. The discriminating system for pornographic information according to claim 15, wherein the file divider transmit the word part to the word comparing engine.

19. The discriminating system for pornographic information according to claim 15, wherein the file divider transmit the picture part to the pornographic picture discerning engine.

20. The discriminating system for pornographic information according to claim 15, wherein the pornographic word database a plurality of database pornographic words.

21. The discriminating system for pornographic information according to claim 20, wherein an inspection method of the word comparing engine is to search and compare word part and the database pornographic words.

22. The discriminating system for pornographic information according to claim 21, wherein word comparing engine calculates the word pornographic index, according to every corresponding pornographic weight for the word part.

23. The discriminating system for pornographic information according to claim 15, wherein the word comparing engine sends the word pornographic index to the pornographic picture discerning engine.

24. The discriminating system for pornographic information according to claim 15, wherein the pornographic picture discerning engine judges whether or not the multiplex file is a pornographic file, according to the pornographic discerning index.

25. The discriminating system for pornographic information according to claim 15, wherein the pornographic file is an e-mail attached with a pornographic picture.
